(19) United States
(12) Patent Application Publication
(10) Pub. No.: US 2005/0132331 A1
(43) Pub. Date: Jun. 16, 2005

(54) Assisting in configuring network devices

(76) Inventor: Joseph S. Wood, Andover, MA (US)

Correspondence Address: DARBY & DARBY P.C., P.O. BOX 5257, NEW YORK, NY, 10150-6257, US

(21) Appl. No.: 10/737,696

(22) Filed: Dec. 15, 2003

(51) Int. Cl. G06F 9/44

(52) U.S. Cl. 717/121; 717/176

(57) ABSTRACT

Interfaces, methods, devices and data structures assist in configuring network devices with operating systems and software application packages that are compatible with each other. An interface renders various network devices, operating systems, and software application packages available for selection. When one of them is selected, the interface enables for further selection those that are compatible with the selected item, while disabling from further selection those that are incompatible. The interface enables selection of more of the compatible items, and updates the remaining compatible items to be further selectable. A data structure includes items that represent the network devices, operating systems, and software application packages. Compatibility objects refer to pairs of the items that are known to be compatible. Constraint objects denote constraints in specific pairs of compatible items, and are also referred to by the appropriate compatibility objects.

### 1. FIELD OF THE INVENTION

The present invention is related to the field of configuring network devices for operation in communication networks, and more specifically to interfaces, methods, devices and data structures for assisting in configuring network devices with compatible operating systems and software application packages.

### 2. BACKGROUND

Network devices are used for communication networks, such as intranets, local area networks, and the internet. Network devices use operating systems and software application packages. Increasingly, network devices, operating systems, and software application packages become upgraded, with new versions and whole new generations being introduced. This on going progress creates continuously a question of which new version or a new generation of a device or operating system or application software package is compatible with which.

### BRIEF DESCRIPTION OF THE DRAWINGS

The invention will become more readily apparent from the following Detailed Description, which proceeds with reference to the accompanying drawings, in which:

FIG. 1 shows a schematic diagram of an illustrative computer system presenting an operating environment for the present invention;

FIG. 2 illustrates a flowchart illustrating an operation of an exemplary interface;

FIGS. 3A-3D illustrate exemplary display content listings occurring successively when using an interface;

FIG. 4 illustrates a screen view of an displaying the contents of FIG. 3C;

FIG. 5 illustrates an exemplary data structure representing items, compatibility objects representing compatibility relationships, and constraint objects representing compatibility constraints;

FIG. 6 illustrates sample relationships between elements of the data structure of FIG. 5; and

FIGS. 7A-7D illustrate an example of usage of the data of the date structure of FIG. 5 according to embodiments of the invention.

### DETAILED DESCRIPTION

The present invention is now described. While it is disclosed in its preferred form, the specific embodiments of the invention as disclosed herein and illustrated in the drawings are not to be considered in a limiting sense. Rather, these embodiments are provided so that this disclosure will be thorough and complete, and will fully convey the scope of the invention to those skilled in the art. Indeed, it should be readily apparent in view of the present description that the invention may be modified in numerous ways. Among other things, the present invention may be embodied as devices, methods, software, and so on. Accordingly, the present invention may take the form of an entirely hardware embodiment, an entirely software embodiment or an embodiment combining software and hardware aspects. The following detailed description is, therefore, not to be taken in a limiting sense.

Throughout the specification, the meaning of “a,” “an,” and “the” may also include plural references. The meaning of “in” includes “in” and “on.” The term “coupled” means a direct connection between the items that are connected, or an indirect connection through one or more intermediary devices or components.

Briefly, the present invention provides interfaces, methods, devices, and data structures for assisting in configuring network devices with operating systems and software application packages that are compatible with each other. An interface according to one embodiment of the invention renders various network devices, operating systems, and software application packages available for selection. When one of them is selected, the interface enables for further selection those that are compatible with the selected item, while disabling from further selection those that are incompatible. The interface enables selection of more items, and updates the remaining compatible items to be further selectable. In some embodiments, the items are displayed in a hierarchical tree. Accordingly, the user can see their options continuously, and also see how making any one choice affects further choices. And they will be protected from attempting to use items that are incompatible with each other.

A data structure according to an embodiment of the invention includes items that represent the network devices, operating systems, and software application packages. The data structure also includes compatibility objects, with each compatibility object referring to two of the items that are known to be compatible. The data structure further includes constraint objects, with each constraint object denoting a constraint of a specific pair of compatible items. The constraint object is also referred to by the compatibility object that refers to the specific pair. As new versions or generations of an item are introduced, updating may be performed by simply adding corresponding new items to the data structure. And as compatibilities between the newly introduced items are confirmed, compatibility objects and compatibility constraints may also be added. Previous data is not lost, and does not need to be adapted in view of new entries.

The invention is now described in more detail.

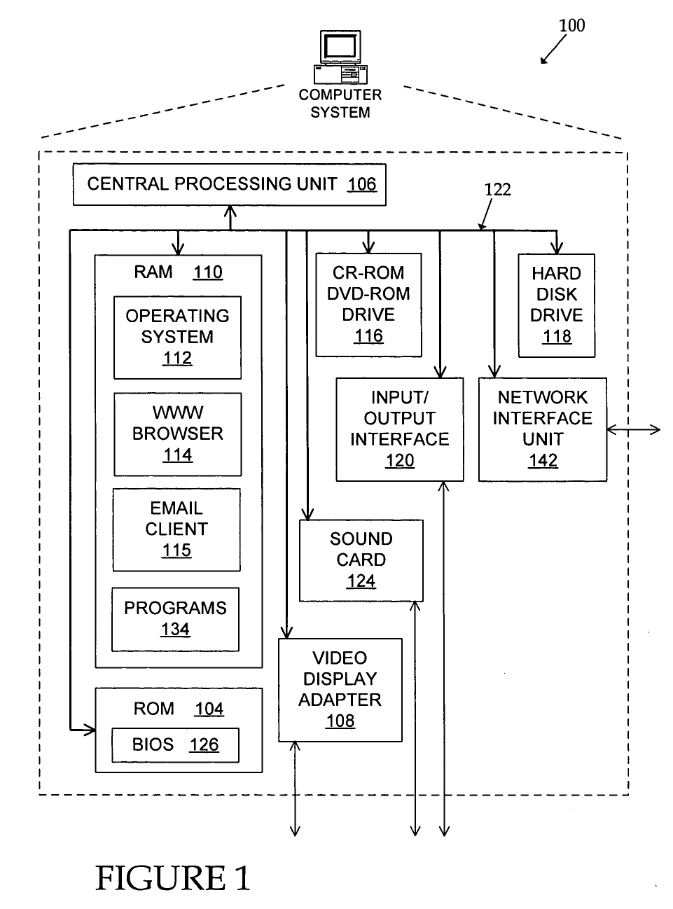

FIG. 1 shows a schematic diagram of illustrative computer system 100, which presents an operating environment for the invention. Not all the components may be required to practice the invention, and variations in the arrangement and type of the components may be made without departing from the spirit or scope of the invention.

Computer system 100 includes central processing unit (CPU) 106, video display adapter 108, and memory. The memory generally includes random access memory (“RAM”) 110, read-only memory (“ROM”) 104 and a permanent mass storage device, such as CD-ROM/DVD-ROM drive 116, a hard disk drive 118, a tape drive (not shown), an optical drive (not shown), and/or a floppy disk drive (not shown).

The memory stores operating system 112, Basic Input/Output System (“BIOS”) 126, and programs 134, for controlling the operation of computer system 100. It will be appreciated that these components may be stored on a computer-readable medium, and loaded into the memory of computer system 100. Loading may be using a drive mechanism associated with the computer-readable medium.

The memory as described above illustrates a type of computer-readable media, namely computer storage media. Computer storage media may include volatile and nonvolatile, removable and non-removable media, which can implemented in any method or technology for storage of information, such as computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Input/output interface 120 may also be provided for communicating with external devices. Communicating includes receiving input from a mouse, keyboard, scanner, or other input device. The memory, network interface unit 142, video display adapter 108, and input/output interface 120 are all connected to processing unit 106 via bus 122. Other peripherals may also be connected to CPU 106 in a similar manner.

Computer system 100 may also be coupled to a communication network, remotely and locally, to exchange data. Coupling may be by twisted pair, fiber optics, coaxial cable, analog telephone lines, full or fractional dedicated digital lines including T1, T2, T3, and T4, Integrated Services Digital Networks (ISDNs), Digital Subscriber Lines (DSLs), wireless links, or other communication links known to those skilled in the art.

As shown in FIG. 1, computer system 100 includes network interface unit 142 for coupling to a network. Those of ordinary skill in the art will appreciate that network interface unit 142 includes the necessary circuitry for such a connection, and is also constructed for use with various communication protocols including the TCP/IP protocol, the particular network configuration of the LAN or WAN it is to be connecting to, and a particular type of coupling medium. Network interface unit 142 may also be capable of connecting to the Internet through a point to point protocol (“PPP”) connection, or a serial line internet protocol (“SLIP”) connection as known to those skilled in the art. Further, the memory may also include email client 115 for accessing email over a network, and browser application 114 for accessing web sites.

Further, other types of computer systems may be employed with the invention. For example, multiprocessor systems, microprocessor-based or programmable consumer electronics, network PCs, PDAs, wearable computers, and the like.

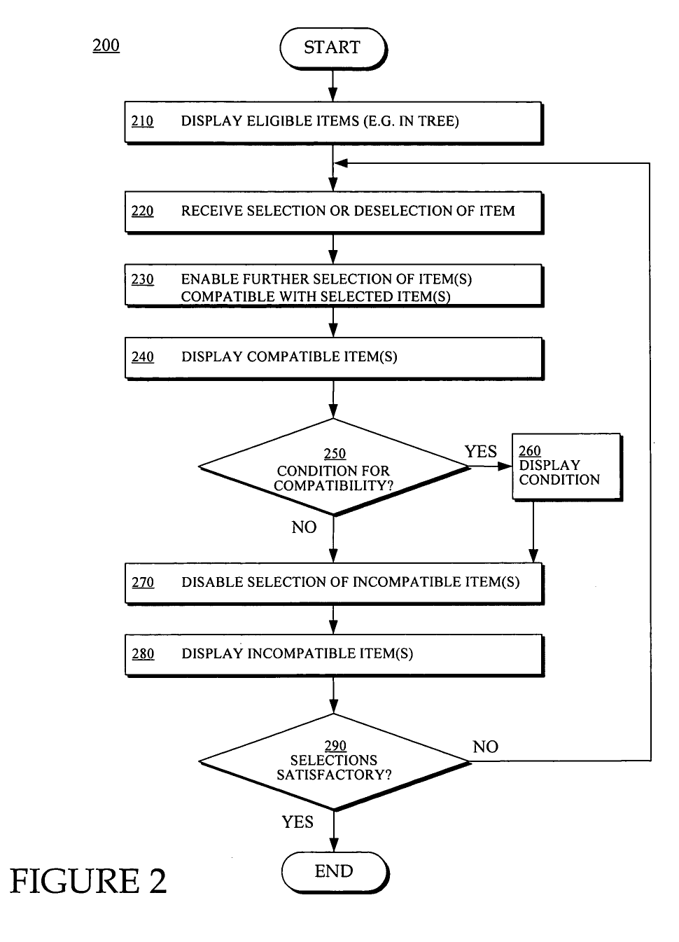

FIG. 2 illustrates flowchart 200 for describing an interface operation according to an embodiment of the invention. The operation of flowchart 200 may be practiced by different embodiments of the invention, including but not limited to computer system 100, a method, and so on.

Moving from a START block, the process advances to block 210, where items eligible for selection are displayed, so as to invite a selection by a user. In one embodiment, the items represent at least network devices, operating systems, and software application packages.

At next block 220, there is received a selection of an item, or a deselection of a previously selected item. A selected item is added to previous selections, and a deselected item is removed from previous selections.

At next block 230, further selection is enabled of items that are compatible with the items selected so far. At next block 240, the identified compatible items may be displayed.

At next block 250, it is inquired whether there is a condition for compatibility of the items selected so far. If there is a condition, then at next block 260 the condition may be displayed.

At next block 270, a further selection is disabled of items that are incompatible with the items selected so far. At next block 280, the incompatible items may be displayed. In some embodiments, the incompatible items are displayed differently than the compatible items.

At next block 290, if the selections are satisfactory, the process may end and return to other functions. If not, the process may return to block 220 for another selection or deselection.

As seen above, an interface of the invention may generate displays. Different display content listings are now described.

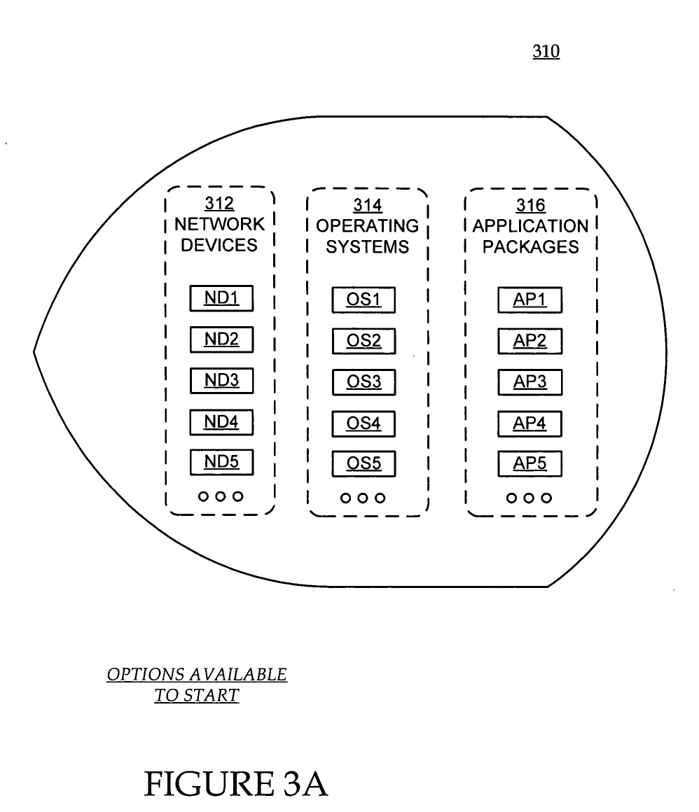

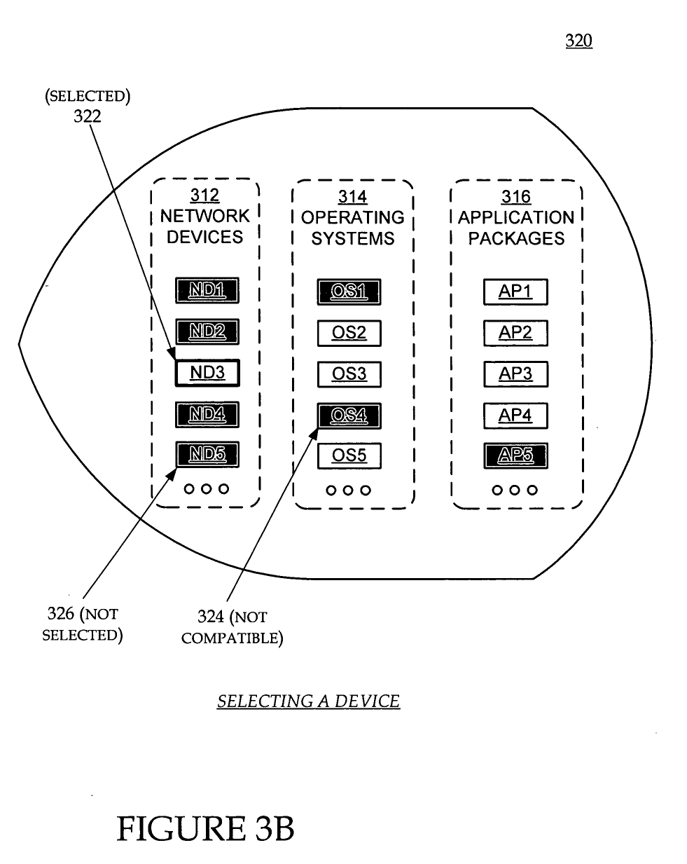

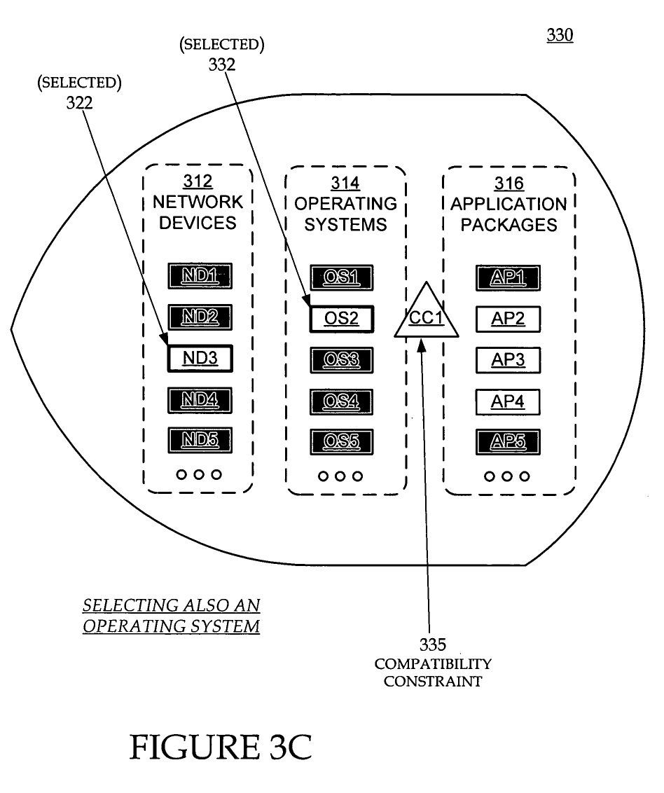

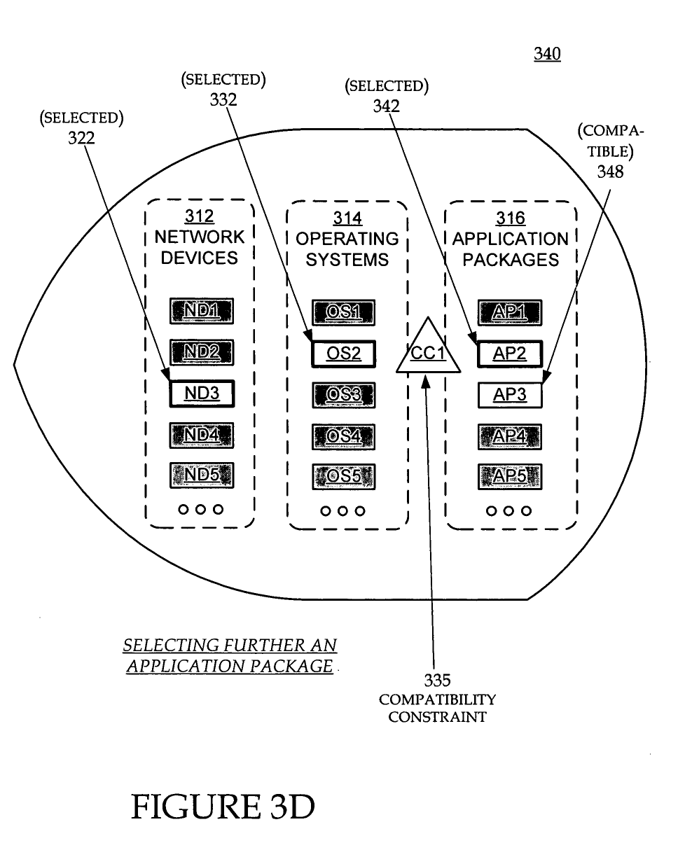

FIG. 3A shows listing 310 of displayed items, which represent network devices (ND1, ND2, ND3, ND4, ND5, . . . ), operating systems (OS1, OS2, OS3, OS4, OS5, . . . ), and software application packages (AP1, AP2, AP3, AP4, AP5, . . . ). Each of the items may be displayed similarly as to the others, so as to invite selection of any one of them.

There are a number of ways to display the items shown in listing 310. In one embodiment, they are displayed by grouping, according to set 312 of network devices, set 314 of operating systems, and set 316 software application packages. Each one of sets 312, 314, 316 may be represented in a hierarchical fashion, such as a hierarchical tree. A tree depiction works well when the various items of any one set also represent multiple versions of network devices, operating systems, and application packages, and for investigating upgrade/downgrade paths.

FIG. 3B shows listing 320, which represents listing 310 of FIG. 3A, after item ND3 322 has been selected. It will be observed that selected item ND3 322 appears different, to suggest that it has been selected. Additionally, items that are compatible with selected item ND3 322 appear in the same way as in FIG. 3A, to suggest they are still eligible for selection, while items incompatible with selected item ND3 322 appear darkened, to suggest they are not eligible for selection. In other embodiments the incompatible items might not be shown at all.

There are at least two reasons why items might be shown as incompatible. In the example of FIG. 3B, operating system OS4 324 would not be compatible with initially selected network device ND3 322, if configured with it. Additionally, already having selected network device ND3 322 simply precludes also selecting another network device ND4 326.

From the display of FIG. 3B, instead of selecting another item, network device ND3 322 may be deselected, in which case the display may revert to the content listing 310 shown in FIG. 3A. A user might do this upon discovering that the initial selection of network device ND3 322 would render ineligible for selection the choice of another, favored item. If selected network device ND3 322 proves satisfactory, however, another item may be further selected.

FIG. 3C shows listing 330, which represents listing 320 of FIG. 3B, after eligible item OS2 332 has been further selected. The selection so far represents network device ND3 operating with operating system OS2, and are thus far compatible with each other. It will be observed that more items have become incompatible from the display of FIG. 3B, and thus appear as ineligible for further selection. Further, selection of any one of the operating systems renders ineligible all the other operating systems.

Additionally, a compatibility constraint CC1 335 appears on display 330. Compatibility constraint CC1 335 represents a condition that must be met, for newly selected item OS2 332 to be compatible with previously selected item ND3 322. From the display of FIG. 3C, one of the two selected items ND3 322 and OS2 332 may be deselected, or a compatible one of the application packages may be selected.

FIG. 3D shows listing 340, which represents listing 330 of FIG. 3C, after eligible item AP2 342 has been further selected, to operate with previously selected items ND3 322 and OS2 332. It will be observed that more, but not all of the application packages in set 316 have become incompatible. In particular, selection of any one of the application packages does not necessarily prohibit all the other application packages in set 316. Application package AP3 348 has remained compatible.

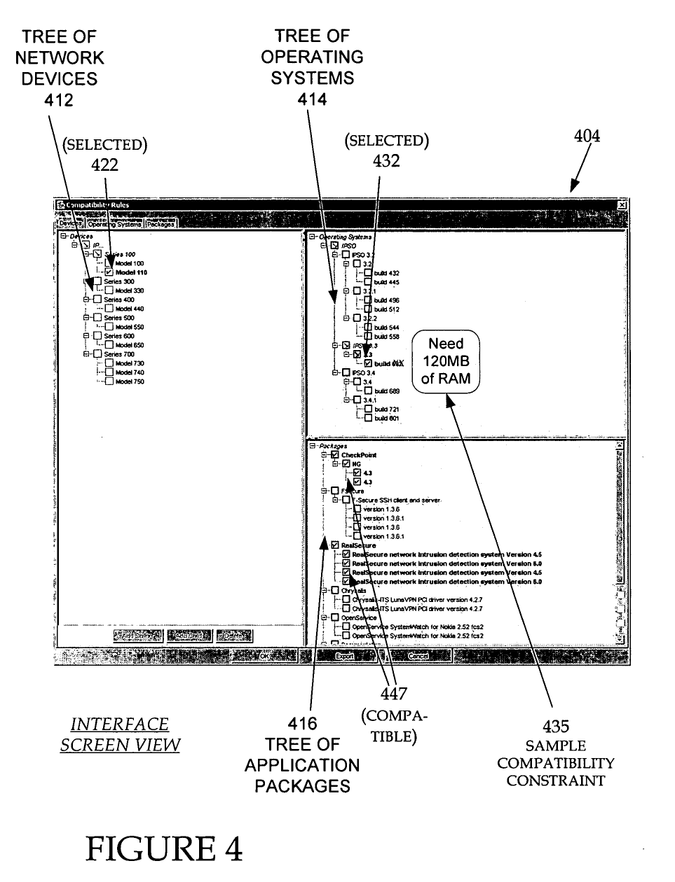

FIG. 4 illustrates screen view 404, which may be an implementation of displaying content listing 330 of FIG. 3C. Available items are shown in three separate windows. More particularly, network devices are shown in a tree 412, operating systems are shown in a tree 414, and application packages are shown in a tree 416. Selection may start from any one of the windows. Further, the windows may be moved with respect to each other, so that the selections will be made from windows in preset places on the screen. For example, it could be arranged that the first selection could be made from the window in the left column, the second selection from the window in the upper right of the screen, and so on.

In screen view 404, network device 422 and operating system 432 have already been selected, as indicated by checkmarks. A compatibility constraint 435 has also been displayed, as a condition that must be met for selected items 422, 432 to be compatible.

Incompatible items are also shown, albeit without a checkmark. Of the remaining items, a number of individually compatible application packages 447 are shown with checkmarks as eligible for selection. Screen view 420 does not indicate, however, whether the individual items 447 are compatible with each other, until one of them is further selected.

The interface of the invention may be implemented in any number of ways. One such way includes using a data structure as described below.

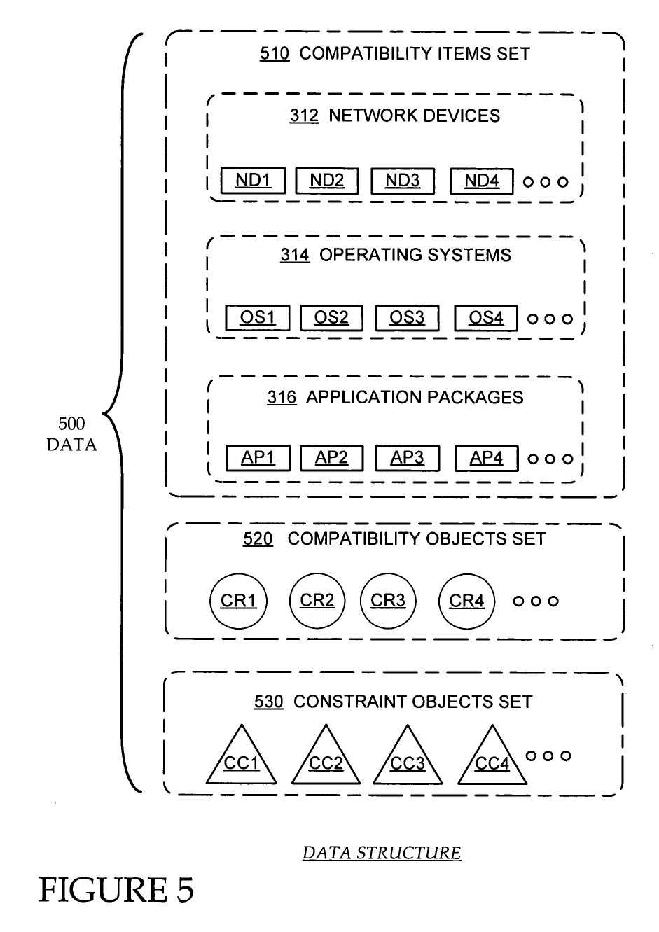

FIG. 5 illustrates an exemplary data structure 500 that may be used according to the invention. Data structure 500 includes compatibility items set 510, compatibility objects set 520, and constraint objects set 530. Set 510 may include at least the previously described network devices set 312, operating systems set 314, and application packages set 316.

Compatibility objects set 520 includes compatibility objects CR1, CR2, CR3, CR4, . . . , each of which defines a compatibility relationship. In one embodiment, each compatibility object refers to at least two of the compatibility items, thus defining that they are compatible if configured together. In this representation, when any two items are not compatible, there is merely no compatibility object that refers to both of them concurrently. An advantage of the data structure is that, as compatibilities are confirmed for newly introduced versions, additional compatibility objects may be generated to describe them, without having to adapt previously generated compatibility objects for earlier versions. Further, a compatibility object might refer to a constraint object, which may be a null set in some instances.

Constraint objects set 530 includes constraint objects CC1, CC2, CC3, CC4, . . . , each of which defines a constraint in a compatibility. Each compatibility constraint in set 530 represents a condition to be obeyed for a pair of two items to be compatible, if configured together. It is advantageous to have the constraint object about the compatibility of the specific pair to be also referred to by the same compatibility object that indicates the compatibility relationship between the specific pair.

Compatibility constraints may include a limitation as to memory size, or CPU speed. They may be implemented with a filter that includes a set of attribute and their values, as well as various comparators. Further, a compatibility constraint might be a requirement that a certain other application be employed, for a selected application to be compatible. The other application might have to be installed and running.

Moreover, either a compatibility constraint or a compatibility relationship or both might be further refined to differentiate in terms of whether another installed application is active or not. In some instances there is no compatibility between two packages X and Y, which means that if X is merely installed, Y may not be active at all, regardless of whether X is active or not. In other instances there is more tolerance, and both may be installed, but only one of them may be running at any one time. In the latter case, it may be chosen to show the items as compatible, with a compatibility constraint pointing out that both may be installed, but only one of them be active at any one time.

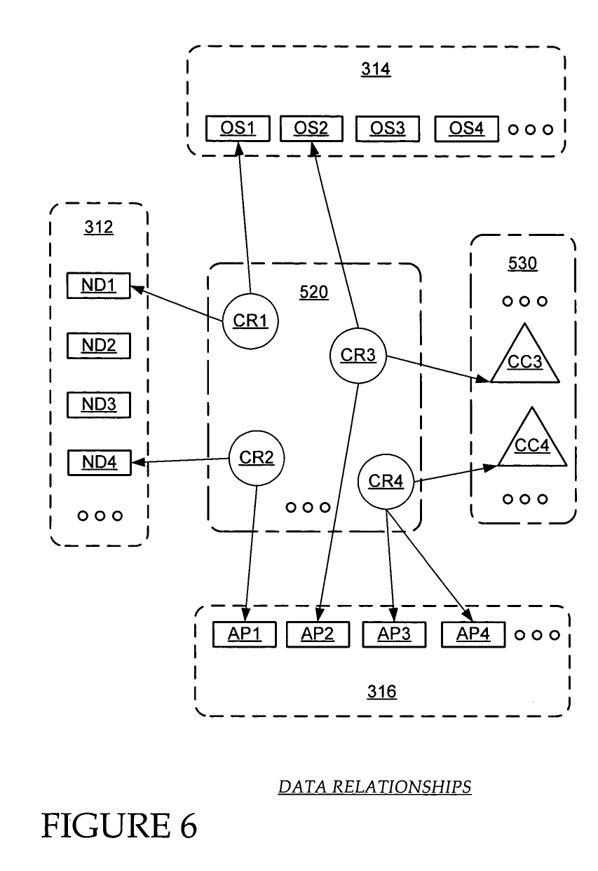

FIG. 6 illustrates some sample relationships between elements of the data structure of FIG. 5. In the example of FIG. 6, compatibility object CR1 refers to network device ND1 and operating system OS1 as compatible. Compatibility object CR2 refers to network device ND4 and application package AP1. Compatibility object CR3 refers to operating system OS2 and application package AP2, along with compatibility constraint CC3. Compatibility object CR4 refers to application packages AP3 and AP4, along with compatibility constraint CC4.

Moreover, if the elements of any one of sets 312, 314, 316 are provided in a hierarchical tree, the elements need to be defined in terms of a name, a place in the tree, and a set of relationships to define the tree. In that case, an item may be implemented as having a parent (possibly a null set) and an array of children (possibly a null set). To prevent having duplicate nodes within a tree, each node must be given a unique name, which is a reasonable requirement since the files they represent are unique in the first place.

In operation, when a first item is selected, such as ND1, at least one of the compatibility objects is found, such as CR1, which refers to selected item ND1. The found compatibility object CR1 is determined to refer to another item, such as OS1, and thus it becomes known that item OS1 is compatible with selected item ND1, and thus a selection of item OS1 becomes enabled. Moreover, if the found compatibility object refers to a compatibility constraint, it is also displayed.

In one embodiment, all the compatibility objects that refer to the first selected item are identified, and thus all the items compatible with the first item become known, and their selection becomes enabled. Further, the remainder of the items become known, and their selection is disabled. That is because they are deemed incompatible with the first item, since they are not referred to by the identified compatibility objects.

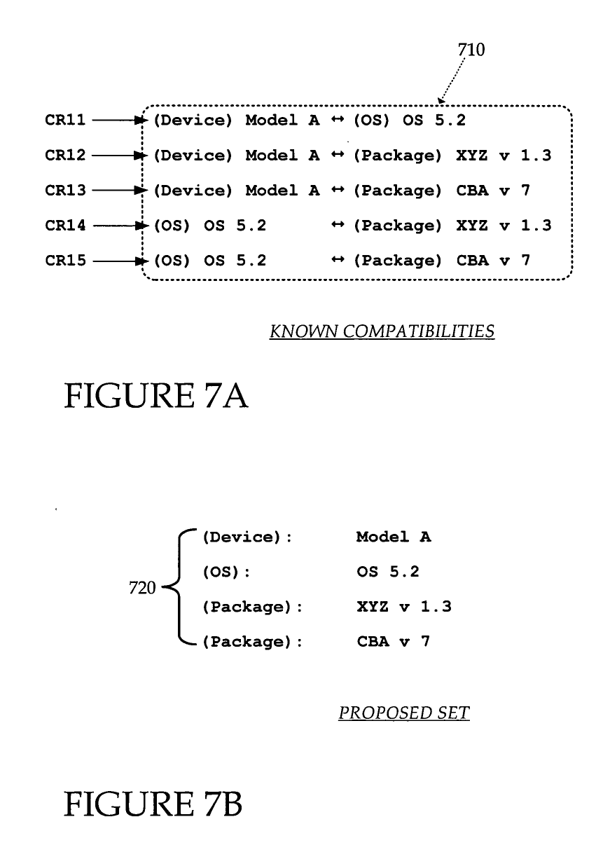

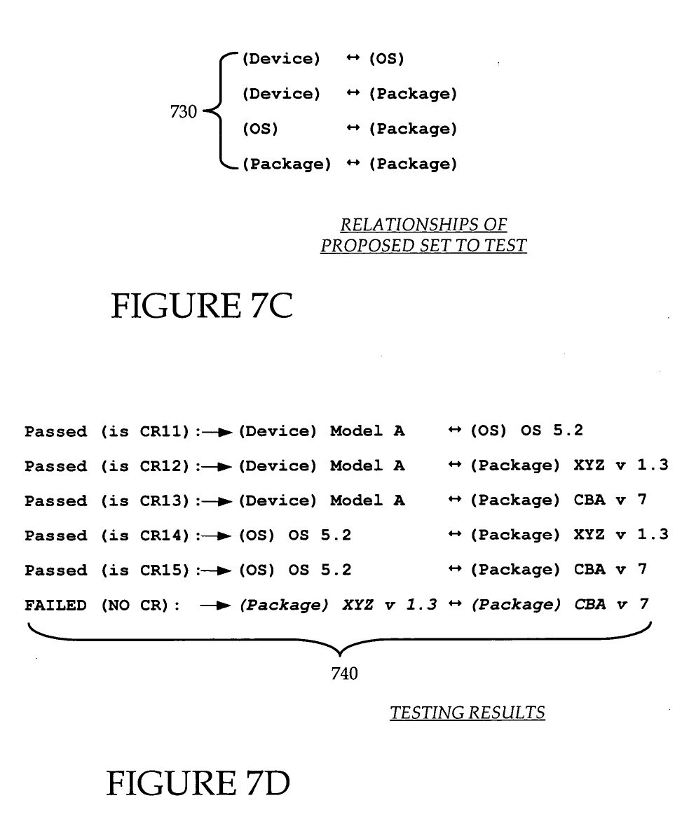

FIGS. 7A-7D illustrate an example of how data structure 500 of FIG. 5 may be used according to embodiments of the invention. FIG. 7A illustrates specific data 710 of some of the known compatibility objects CR11, CR12, CR13, CR14, CR15. Each object refers to a compatibility relationship of two items as compatible with each other, if configured together. For example, compatibility relationship CR11 refers to Model A and to operating system OS 5.2.

FIG. 7B illustrates a set 720 of items that are proposed to operate together. Items in set 720 may be input sequentially, in any order. FIG. 7C shows relationships 730 for testing the compatibilities of the items of 720, individually in pairs. As seen in FIG. 7D, individual pairs 740 are formed and tested. The last proposed pair has no compatibility object, and therefore the compatibility test of the whole proposed set 720 fails.

Numerous details have been set forth in this description, which is to be taken as a whole, to provide a more thorough understanding of the invention. In other instances, well-known features have not been described in detail, so as to not obscure unnecessarily the invention.

The invention includes combinations and subcombinations of the various elements, features, functions and/or properties disclosed herein. The following claims define certain combinations and subcombinations, which are regarded as novel and non-obvious. Additional claims for other combinations and subcombinations of features, functions, elements and/or properties may be presented in this or a related document.

1. A method for assisting in configuring a network device with an operating system and at least one software application, comprising:
receiving an initial selection of a first one of a plurality of items that represents one of network devices, network operating systems, and software applications; and
enabling a further selection of a second one of the items that represents another one of the network devices, the network operating systems, and the software applications, wherein the second item is compatible with the first represented item if configured with it.

2. The method of claim 1, further comprising:
displaying as eligible for selection at least some of the items for receiving the initial selection.

3. The method of claim 1, further comprising:
displaying the first item as having been initially selected.

4. The method of claim 1, further comprising:
receiving a deselection of the first selected item.

5. The method of claim 1, further comprising:
identifying one of a plurality of compatibility objects that refers to the first item; and
identifying the second item as referred to by the identified compatibility object.

6. The method of claim 1, further comprising:
receiving a further selection for the second item; and
enabling a further selection of items that represent one more of the network devices, the network operating systems, and the software applications, and are compatible with the first represented item and the second represented item if configured with it.

7. The method of claim 6, further comprising:
displaying a condition to be obeyed in association with the second item becoming compatible for configuration with the first item.

8. The method of claim 7, wherein the condition is that a specific other item be also employed.

9. The method of claim 7, wherein the condition is that a specific selected other item be inactive.

10. The method of claim 7, further comprising:
identifying one of a plurality of compatibility objects that refers to the second item; and
identifying the condition as referred to by the identified compatibility object.

11. The method of claim 1, wherein
the first item belongs in a first menu with certain others of the items, and
further comprising disabling a further selection of the items in the first menu responsive to receiving the selection of the first item.

12. The method of claim 11, further comprising:
displaying the items in the first menu in a hierarchical tree.

13. The method of claim 11, further comprising:
receiving a subsequent selection of the enabled second item, the second item belonging in a second menu with certain others of the items; and
disabling a further selection of the items in the second menu responsive to receiving the selection of the second item.

14. The method of claim 1, further comprising:
disabling a further selection of a third one of the items that represents one of the network devices, the network operating systems, and the software applications that is incompatible with the first represented item if configured with it.

15. The method of claim 14, further comprising:
displaying the third item as ineligible for selection.

16. The method of claim 14, further comprising:
identifying those of a plurality of compatibility objects that refer to the first item;
identifying the third item as not referred to by the identified compatibility objects.

17. An interface for enabling a user to communicate with a computer processor for assisting in configuring a network device with an operating system and at least one software application, the interface including instructions which, when performed by the processor, result in actions comprising:
receiving an initial selection of a first one of a plurality of items that represents one of network devices, network operating systems, and software applications; and
enabling a further selection of a second one of the items that represents another one of the network devices, the network operating systems, and the software applications, wherein the second item is compatible with the first represented item if configured with it.

18. The interface of claim 17, the actions further comprising:
displaying as eligible for selection at least some of the items for receiving the initial selection.

19. The interface of claim 17, the actions further comprising:
identifying one of a plurality of compatibility objects that refers to the first item; and
identifying the second item as referred to by the identified compatibility object.

20. The interface of claim 17, the actions further comprising:
receiving a further selection for the second item; and
enabling a further selection of items that represent one more of the network devices, the network operating systems, and the software applications, and are compatible with the first represented item and the second represented item if configured with it.

21. The interface of claim 20, the actions further comprising:
displaying a condition to be obeyed in association with the second item becoming compatible for configuration with the first item.

22. The interface of claim 21, the actions further comprising:
identifying one of a plurality of compatibility objects that refers to the second item; and
identifying the condition as referred to by the identified compatibility object.

23. The interface of claim 17, wherein
the first item belongs in a first menu with certain others of the items, and
further comprising disabling a further selection of the items in the first menu responsive to receiving the selection of the first item.

24. The interface of claim 23, the actions further comprising:
displaying the items in the first menu in a hierarchical tree.

25. The interface of claim 17, the actions further comprising:
disabling a further selection of a third one of the items that represents one of the network devices, the network operating systems, and the software applications that is incompatible with the first represented item if configured with it.

26. The interface of claim 25, the actions further comprising:
displaying the third item as ineligible for selection.

27. The interface of claim 25, the actions further comprising:
identifying those of a plurality of compatibility objects that refer to the first item;
identifying the third item as not referred to by the identified compatibility objects.

28. A computer system for assisting in configuring a network device with an operating system and at least one software application, comprising:
a memory for storing logical instructions;
a processor for executing the logical instructions stored in the memory, the execution of the logical instructions causing actions to be performed, including:
receiving an initial selection of a first one of a plurality of items that represents one of network devices, network operating systems, and software applications; and
enabling a further selection of a second one of the items that represents another one of the network devices, the network operating systems, and the software applications, wherein the second item is compatible with the first represented item if configured with it.

29. The computer of claim 28, wherein the actions further include:
displaying as eligible for selection at least some of the items for receiving the initial selection.

30. The computer of claim 28, wherein the actions further include:
disabling a further selection of a third one of the items that represents one of the network devices, the network operating systems, and the software applications that is incompatible with the first represented item if configured with it.

31. The computer of claim 28, wherein the actions further include:
receiving a further selection for the second item; and
enabling a further selection of items that represent one more of the network devices, the network operating systems, and the software applications, and are compatible with the first represented item and the second represented item if configured with it.

32. The computer of claim 28, wherein
the first item belongs in a first menu with certain others of the items, and
further comprising disabling a further selection of the items in the first menu responsive to receiving the selection of the first item.

33. The computer of claim 32, wherein the actions further include:
displaying the items in the first menu in a hierarchical tree.

34. A device comprising:
means for receiving an initial selection of a first one of a plurality of items that represents one of network devices, network operating systems, and software applications; and
means for enabling a further selection of a second one of the items that represents another one of the network devices, the network operating systems, and the software applications, wherein the second item is compatible with the first represented item if configured with it.

35. The device of claim 34, further comprising:
means for disabling a further selection of a third one of the items that represents one of the network devices, the network operating systems, and the software applications that is incompatible with the first represented item if configured with it.

36. A data structure comprising:
a plurality of items, each item representing one of at least a network device, an operating system, and a software application; and
a plurality of compatibility objects referring to the items, wherein at least a selected one of the compatibility objects refers to at least two of the items that are compatible if configured together.

37. The data structure of claim 36, wherein
a first group of the items belong in one of a network devices set, a network operating systems set, and a software applications set, and
the items of the first group are defined in terms of a name and a place in a hierarchy in the set.

38. The data structure of claim 36, further comprising:
a plurality of constraint objects, wherein the selected compatibility object further refers to one of the constraint objects that represents a condition to be obeyed for the two referred to compatibility items to be compatible if configured together.

39. A computer-readable medium containing data comprising:
a plurality of items, each item representing one of at least a network device, an operating system, and a software application; and
a plurality of compatibility objects referring to the items, wherein at least a selected one of the compatibility objects refers to at least two of the items that are compatible if configured together.

40. The medium of claim 39, wherein
a first group of the items belong in one of a network devices set, a network operating systems set, and a software applications set, and
the items of the first group are defined in terms of a name and a place in a hierarchy in the set.

41. The medium of claim 39, further comprising:
a plurality of constraint objects, wherein the selected compatibility object further refers to one of the constraint objects that represents a condition to be obeyed for the two referred to compatibility items to be compatible if configured together.
